(19) United States
(12) Patent Application Publication
(10) Pub. No.: US 2026/0131819 A1
(43) Pub. Date: May 14, 2026

(54) ATTENTION ATTRACTING DEVICE AND ATTENTION ATTRACTING METHOD

(71) Applicant: HONDA MOTOR CO., LTD., Tokyo (JP)

(72) Inventors: Haruko Okuyama, Wako-shi (JP); Tatsuya Iwasa, Wako-shi (JP); Tsuyoshi Nojiri, Wako-shi (JP); Toshihiro Hashimoto, Wako-shi (JP); Yuichiro Shimura, Wako-shi (JP)

(21) Appl. No.: 19/361,529

(22) Filed: Oct. 17, 2025

(30) Foreign Application Priority Data
Nov. 12, 2024 (JP) 2024-197709

(51) Int. Cl. B60W 50/16; B60W 30/095; B60W 40/08; B60W 50/00; B60W 50/14; G06V 20/59; G06V 40/16

(52) U.S. Cl. CPC B60W 50/16; B60W 30/0956; B60W 40/08; G06V 20/597; G06V 40/174; B60W 2040/0872; B60W 2040/089; B60W 2050/0083; B60W 2050/143; B60W 2050/146; B60W 2420/403; B60W 2540/21; B60W 2540/215; B60W 2540/22; B60W 2540/221

(57) ABSTRACT

An attention attracting device includes: a risk index value acquisition unit that acquires a risk index value; a geographical characteristic acquisition unit that acquires a geographical characteristic of a driver of a vehicle; a driver status recognition unit that recognizes a status of the driver of the vehicle; a driver emotion estimation unit that estimates an emotion of the driver based on a recognition result of the status of the driver D; and a notification determination unit that determines a level of notification to notify the driver of the presence of a risk and a type of an HMI device to be used for notification, based on the emotion of the driver estimated by the driver emotion estimation unit, the geographical characteristic of the driver acquired by the geographical characteristic acquisition unit, and the risk index value acquired by the risk index value acquisition unit.

### INCORPORATION BY REFERENCE

The present application claims priority under 35 U.S.C. § 119 to Japanese Patent Application No. 2024-197709 filed on Nov. 12, 2024. The content of the application is incorporated herein by reference in its entirety.

### BACKGROUND OF THE INVENTION

### Field of the Invention

The present invention relates to an attention attracting device and an attention attracting method.

### Description of the Related Art

In recent years, there has been known a device that outputs information using a language corresponding to a passenger who is in a vehicle.

For example, Japanese Patent Laid-Open No. 2022-056875 discloses a system having a function of accepting country or language setting from a user and a function of outputting information using the set country or language.

In addition, an in-vehicle information display device disclosed in Japanese Patent Laid-Open No. 2019-113520 includes a face image capturing unit that captures a face image of a user, a nationality narrowing-down unit that narrows down nationality of the user based on the captured face image, a language-in-use estimation unit that selects a language of a call to call the user based on the narrowed-down nationality and estimates a language used by the user based on a result of response from the user to the call, and a display control unit that displays a display screen understandable to the user using the estimated language-in-use.

In a case of notifying a driver of the presence of a risk, there is a need to reduce erroneous recognition of the driver by notifying the driver using a plurality of means, such as sound and color, in addition to a display with a text. However, there is a problem in that emotions evoked by the driver may differ depending on cultural characteristics and social background of the driver, which may lead to erroneous recognition. The present application aims to improve visibility in order to solve the above problem. In addition, the present application aims to further improve traffic safety and contribute to development of a sustainable transportation system.

### SUMMARY OF THE INVENTION

An aspect of the present invention provides an attention attracting device that notifies a driver of a vehicle of a presence of a risk using a plurality of types of HMI devices, the attention attracting device including: an index value acquisition unit that acquires, based on outputs of a plurality of sensors mounted on the vehicle, a risk index value indicating a degree of possibility of contact between the vehicle and a target object present around the vehicle; a geographical characteristic acquisition unit that acquires a geographical characteristic of the driver of the vehicle; a status recognition unit that recognizes a status of the driver of the vehicle; an emotion estimation unit that estimates an emotion of the driver based on a result of the status of the driver recognized by the status recognition unit; and a determination unit that determines a level of notification to notify the driver of the presence of the risk and a type of the HMI device to be used for notification, based on the emotion of the driver estimated by the emotion estimation unit, the geographical characteristic of the driver acquired by the geographical characteristic acquisition unit, and the risk index value acquired by the index value acquisition unit.

In another aspect of the present invention, the plurality of types of HMI devices includes a visual HMI device that visually transmits information to the driver, an auditory HMI device that transmits information to the driver with a voice, and a tactile HMI device that provides a tactile stimulus to the driver, and the determination unit determines, as the HMI device to be used for notification, at least one of the visual HMI device, the auditory HMI device, and the tactile HMI device, based on the emotion of the driver, the geographical characteristic of the driver, and the risk index value.

In another aspect of the present invention, the determination unit is configured to determine a value of a visual parameter for changing an image displayed by the visual HMI device from the level of notification determined based on the risk index value, and the visual parameter includes a parameter for changing at least one of enlargement and reduction of the image, a display area of the image, display luminance of the image, a display color of the image, a shape of the image, and a blinking cycle of the image.

In another aspect of the present invention, the determination unit is configured to determine a value of an auditory parameter for changing a voice output by the auditory HMI device from the level of notification determined based on the risk index value, and the auditory parameter includes a parameter for changing at least one of a playback speed or a playback cycle, a volume of sound, and a voice pitch of voice data which is a source of the voice.

In another aspect of the present invention, the determination unit is configured to determine a value of a tactile parameter for changing a level of vibration output by the tactile HMI device from the level of notification determined based on the risk index value, and the tactile parameter includes a parameter for changing at least one of a period of the vibration, an amplitude of the vibration, and a waveform of the vibration.

Another aspect of the present invention provides an attention attracting method of causing a processor mounted on an attention attracting device, which notifies a driver of a vehicle of a presence of a risk using a plurality of types of HMI devices, to execute: an index value acquisition step of acquiring, based on outputs of a plurality of sensors mounted on the vehicle, a risk index value indicating a degree of possibility of contact between the vehicle and a target object present around the vehicle; a geographical characteristic acquisition step of acquiring a geographical characteristic of the driver of the vehicle; a status recognition step of recognizing a status of the driver of the vehicle; an emotion estimation step of estimating an emotion of the driver based on a result of the status of the driver recognized in the status recognition step; and a determination step of determining a level of notification to notify the driver of the presence of the risk and a type of the HMI device to be used for notification, based on the emotion of the driver estimated in the emotion estimation step, the geographical characteristic of the driver acquired in the geographical characteristic acquisition step, and the risk index value acquired in the index value acquisition step.

According to an aspect of the present invention, in a case of notifying the driver of the presence of the risk using the plurality of types of HMI devices, there may be differences in emotions evoked by the driver depending on the cultural characteristics or social background, resulting in erroneous recognition of the notification of the presence of the risk. Therefore, when the level of notification to notify the driver of the presence of the risk and the type of the HMI device to be used for notification are determined based on the geographical characteristic of the driver and the emotion of the driver, it is possible to reduce the possibility of erroneous recognition of information to be notified to the driver and increase the certainty of the notification to the driver.

### BRIEF DESCRIPTION OF THE DRAWINGS

FIG. 1 is a diagram illustrating a configuration of a control system of a vehicle;

FIG. 2 is a view illustrating a configuration of a vehicle interior of the vehicle;

FIG. 3 is a diagram illustrating an example of an emotion map;

FIG. 4 is a diagram illustrating an example of a first notification setting table;

FIG. 5 is a diagram illustrating an example of a second notification setting table;

FIG. 6 is a diagram illustrating an example of a third notification setting table;

FIG. 7 is a flowchart illustrating an operation of an attention attracting device;

FIG. 8 is a flowchart illustrating emotion estimation processing; and

FIG. 9 is a flowchart illustrating target object detection processing.

### DETAILED DESCRIPTION OF THE INVENTION

### 1. Configuration of Vehicle

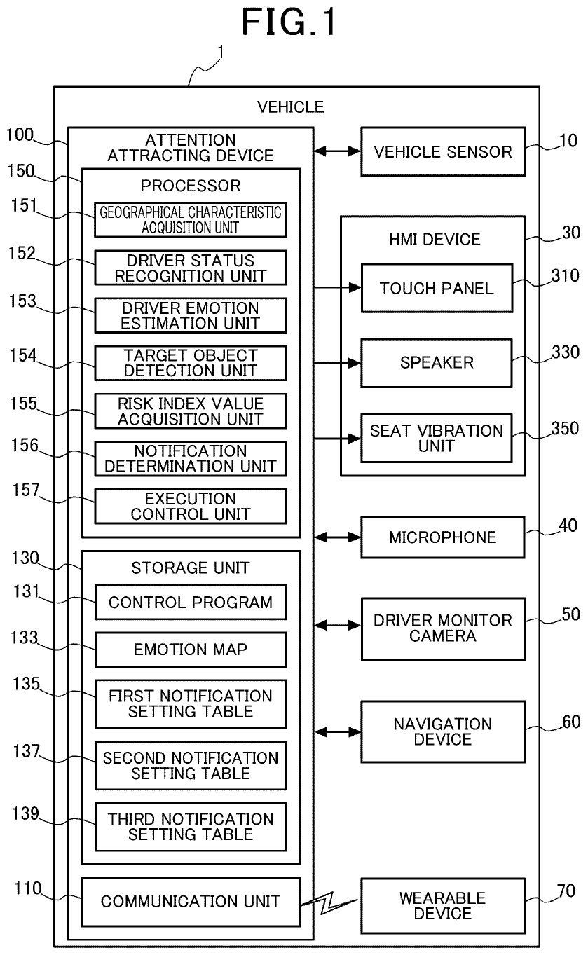

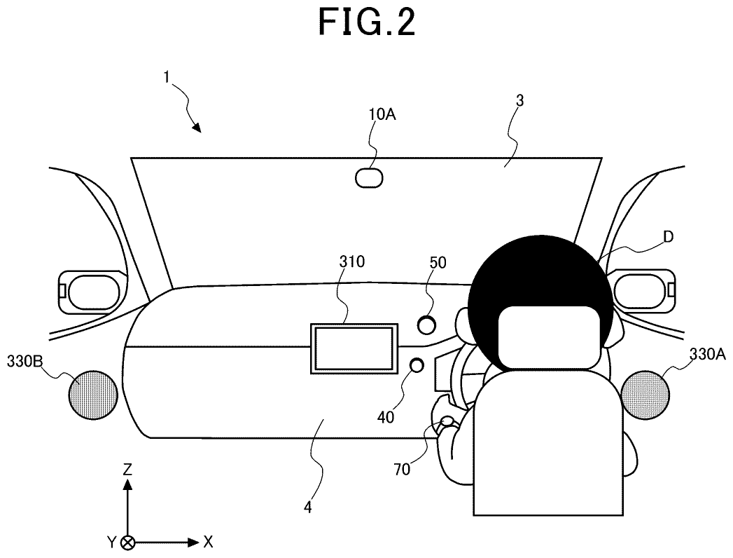

FIG. 1 is a diagram illustrating a configuration of a control system of an attention attracting device 100, and FIG. 2 is a view illustrating a configuration of a front interior of a vehicle 1 mounted with the attention attracting device 100. An X-axis, a Y-axis, and a Z-axis illustrated in FIG. 2 are orthogonal to each other. The Z-axis indicates an up-down direction. The X-axis and the Y-axis are parallel to a horizontal direction when the vehicle 1 is traveling. The X-axis indicates a left-right direction as a vehicle width direction of the vehicle 1. The Y-axis indicates a front-rear direction of the vehicle 1. A positive direction of the X-axis indicates a right direction. A positive direction of the Y-axis indicates a front direction. A positive direction of the Z-axis indicates an up direction.

The vehicle 1 is mounted with a vehicle sensor 10, an HMI (Human Machine Interface) device 30, a microphone 40, a driver monitor camera 50, a navigation device 60 (computer), and an attention attracting device 100. In addition, a driver D of the vehicle 1 wears a wearable device 70 (computer) on the arm of the driver D, for example.

The vehicle sensor 10 includes at least one of one or more cameras, radar, lidar, and sonar distributed around a body of the vehicle 1, and detects target objects that are present around the vehicle 1 and are to be notified. The target objects are objects that may collide with or come into contact with the vehicle 1, and need to be notified to the driver of the vehicle 1 of the presence thereof. The vehicle sensor 10 outputs data measured by the cameras, radar, lidar, or sonar to the attention attracting device 100, as sensor data.

FIG. 2 illustrates, as an example of the vehicle sensor 10, a front camera 10A that is mounted on an upper part of a windshield 3 of the vehicle 1 and captures an image in front of the vehicle 1.

The HMI device 30 is a device that provides a stimulus to the driver D of the vehicle 1. The HMI device 30 of the present embodiment includes a touch panel 310 that transmits visual information to a visual sense of the driver D, a speaker 330 that transmits auditory information to the driver D, and a seat vibration unit 350 that provides a tactile stimulus to the driver D. The touch panel 310 corresponds to a visual HMI device, the speaker 330 corresponds to an auditory HMI device, and the seat vibration unit 350 corresponds to a tactile HMI device.

In the configuration example of the front interior of the vehicle 1 illustrated in FIG. 2, the touch panel 310 is mounted on a dashboard 4 of the vehicle 1, and the speaker 330 includes a right speaker 330A provided on a driver's seat side of the vehicle 1 and a left speaker 330B provided on a passenger's seat side. The touch panel 310 displays visual information and also functions as a receiving unit that receives input information input from the driver D.

The seat vibration unit 350 is provided in a seat in which the driver D sits. The seat vibration unit 350 includes, for example, a vibration motor that generates vibrations in the seat in which the driver sits, and drives the vibration motor based on a vibration control signal input from the attention attracting device 100. Thus, a tactile stimulus is provided to the driver D. The HMI device 350, which provides the tactile stimulus to the driver D, may be an electric seat belt that changes tension of the seat belt to provide the tactile stimulus to the driver.

In addition, the microphone 40 and the driver monitor camera 50 are disposed on the dashboard 4 of the vehicle 1. The microphone 40 collects a voice spoken from the driver D. The microphone 40 converts the collected spoken voice into digital voice data, and outputs the converted voice data to the attention attracting device 100. The driver monitor camera 50 captures an image of the driver D seated in the driver's seat of the vehicle 1. The driver monitor camera 50 generates a captured image including a face of the driver D, and outputs the generated captured image to the attention attracting device 100.

The wearable device 70 worn on the arm of the driver D measures biometric information of the driver D as a wearer, for example, a heart rate, a body temperature, and a blood pressure. The wearable device 70 is wirelessly connected to the attention attracting device 100 via short-range wireless communication and transmits the measured biometric information to the attention attracting device 100.

The navigation device 60 searches for a guided route, which is a route to a destination set by passengers including the driver D of the vehicle 1, and executes route guidance to the destination by allowing the touch panel 310 to display the searched guided route.

### 2. Configuration of Attention Attracting Device

Next, a configuration of the attention attracting device 100 will be described. The attention attracting device 100 is configured by an ECU or a computer including a communication unit 110 (transmitter/receiver, circuit), a storage unit 130, a processor 150, an input/output interface (not illustrated), and the like.

The communication unit 110 performs short-range wireless communication with the wearable device 70 using specifications of Bluetooth (registered trademark), UWB (Ultra Wide Band), and the like.

The storage unit 130 includes, for example, a non-volatile RAM (Read Only Memory), or ROM and RAM (Random Access Memory). The storage unit 130 may include an auxiliary storage device such as an SSD (Solid State Drive).

The storage unit 130 stores a control program 131 executed by the processor 150, an emotion map 133, a first notification setting table 135, a second notification setting table 137, and a third notification setting table 139. Details of the emotion map 133, the first notification setting table 135, the second notification setting table 137, and the third notification setting table 139 will be described below.

The processor 150 is an arithmetic processing device including a processor such as a CPU (Central Processing Unit) or an MPU (Micro-Processing Unit). The processor 150 may be configured with a single processor, or may be configured with a plurality of processors. In addition, the processor 150 may also be configured with an SoC integrated with part or all of the storage unit 130 or other circuits. The processor 150 may also be configured with a combination of a CPU that executes a program and a DSP (Digital Signal Processor) that executes predetermined arithmetic processing. Furthermore, the processor 150 may have a configuration in which all of functions are implemented in hardware or a configuration using a programmable device.

The attention attracting device 100 includes, as functional units, a geographical characteristic acquisition unit 151, a driver status recognition unit 152, a driver emotion estimation unit 153, a target object detection unit 154, a risk index value acquisition unit 155, a notification determination unit 156, and an execution control unit 157. These functional units are implemented by control of the processor 150 according to the control program 131.

The geographical characteristic acquisition unit 151 acquires geographical characteristics of the driver D of the vehicle 1. The geographical characteristics include a language spoken from the driver D, a country or a region in which the driver D lives, and the like. In addition, the geographical characteristic acquisition unit 151 may be configured to acquire, as the geographical characteristics, culture, a traffic environment, a social background, and the like of each country or region. For example, when the communication unit 110 is connected to the Internet or the like, the geographical characteristic acquisition unit 151 may acquire, via the Internet, culture, a traffic environment, a social background, and the like of a country or a region in which the driver D lives.

The geographical characteristic acquisition unit 151 of the present embodiment acquires, as the geographical characteristics of the driver D, information on the country in which the driver D lives or on the language spoken from the driver D. For example, the geographical characteristic acquisition unit 151 acquires, from the navigation device 60, language setting information of the navigation device 60. Furthermore, the geographical characteristic acquisition unit 151 may also analyze the voice of the driver D input from the microphone 40 to identify a language and acquire information on the language. The geographical characteristic acquisition unit 151 outputs the information on the language, which is used by the driver D and acquired as the acquired geographical characteristic information, to the notification determination unit 156.

The driver status recognition unit 152 corresponds to a status recognition unit. The driver status recognition unit 152 recognizes, as a status of the driver D who is in the vehicle 1, a status of the driver D based on at least one of information input by a touch operation on the touch panel 310, an image of the driver D captured by the driver monitor camera 50, a voice of the driver D input to the microphone 40, and biometric information of the driver D detected by the wearable device 70.

The driver status recognition unit 152 recognizes, as a status of the driver D, the following elements, for example.
First element: An answer input by the touch operation on the touch panel 310 in response to a question such as “How are you feeling today?” that is displayed on the touch panel 310 when the driver D gets into the vehicle 1.
Second element: Facial expression and behavior of the driver D recognized from the image of the driver D.
Third element: Content, intonation, pitch, volume, and accent of the voice spoken from the driver D.
Fourth element: Biometric information (heart rate, blood pressure, body temperature, etc.) of the driver D.

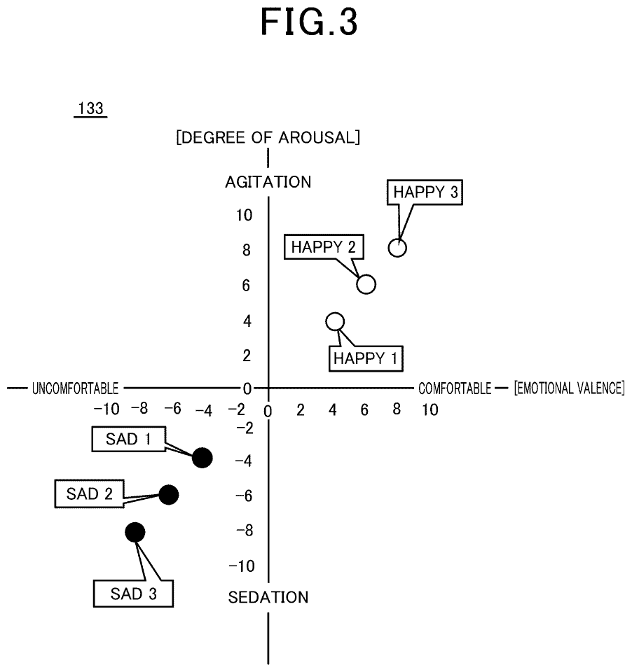

FIG. 3 is a diagram illustrating an example of the emotion map 133.

The driver emotion estimation unit 153 corresponds to an emotion estimation unit. The driver emotion estimation unit 153 estimates an emotion of the driver D based on the status of the driver D recognized by the driver status recognition unit 152. The driver emotion estimation unit 153 estimates the emotion of the driver D with an emotional valence and a degree of arousal as evaluation elements using the emotion map 133 illustrated in FIG. 3. The emotional valence is an evaluation element that indicates from a comfortable level to an uncomfortable level of the driver D, and the degree of arousal is an evaluation element that indicates from an agitation level to a sedation level of the driver D. The driver emotion estimation unit 153 estimates the emotion of the driver D into seven levels of emotionless, sad 1, sad 2, sad 3, happy 1, happy 2, and happy 3, as illustrated in FIG. 3, for example. The driver emotion estimation unit 153 outputs the estimated emotion information of the driver D to the notification determination unit 156.

The driver emotion estimation unit 153 estimates the emotion of the driver D by setting the emotional valence and the degree of arousal to the following levels, for example, based on the first to fourth elements described above.

Regarding the first element, the driver emotion estimation unit 153 sets the emotional valence of the driver D to a relatively high value (for example, 3) when the answer to the question is “as usual”, and sets the degree of arousal to a relatively low value (for example, −3) when the answer to the question is “different from usual”.

Regarding the second element, the driver emotion estimation unit 153 sets the emotional valence of the driver D to a relatively high value (for example, 5) when it is determined based on the facial expression of the driver D that the driver D has a smiley face, and sets the emotional valence to a relatively low value (for example, −5) when it is determined that the driver D has a sullen face. In addition, the driver emotion estimation unit 153 sets the degree of arousal to a relatively high value (for example, 3) when it is determined based on the behavior of the driver D that the driver D is moving restlessly, and sets the degree of arousal to a relatively low value (for example, −3) when it is determined that the driver D is barely moving.

Regarding the third element, the driver emotion estimation unit 153 sets the emotional valence to a relatively high value (for example, 5) when it is determined based on the content of the voice spoken from the driver D that the content is positive, such as praising or expecting something, and sets the emotional valence to a relatively low value (for example, −5) when it is determined that the content is negative, such as criticizing something. In addition, when the content of the voice spoken from the driver D involves a specific keyword (such as “Like” or “Super Like”), the driver emotion estimation unit 153 sets values of the emotional valence and the degree of arousal associated with the keyword.

Furthermore, the driver emotion estimation unit 153 sets the degree of arousal to a relatively high value (for example, 3) when it is determined based on the voice pitch (frequency) of the driver D that the voice of the driver D is equal to or higher than a predetermined pitch, and sets the degree of arousal to a relatively low value (for example, −3) when it is determined that the voice of driver D is below the predetermined pitch.

Regarding the fourth element, the driver emotion estimation unit 153 sets the emotional valence and the degree of arousal by applying a detection value of the biometric information (heart rate, blood pressure, body temperature, etc.) of the driver D to a correspondence table of detection values, emotional valences, and degrees of arousal prepared in advance. The correspondence table may be created based on the profile of the driver D input by the driver D or the biometric information of the driver D detected in the past.

In addition, the driver emotion estimation unit 153 may recognize vales of the emotional valence and the degree of arousal, based on the change in the traveling speed of the vehicle 1 detected by a speed sensor, the behavior of the vehicle 1 detected by a gyro sensor, the change in the traveling position of the vehicle 1 detected by a GNSS (Global Navigation Satellite Systems) sensor, and the like. The speed sensor, the gyro sensor, and the GNSS sensor are not illustrated. Furthermore, the driver emotion estimation unit 153 may estimate the emotion of the driver D based on either the emotional valence or the degree of arousal, or based on other evaluation elements.

The target object detection unit 154 detects, based on the sensor data input from the vehicle sensor 10, target objects present around the vehicle 1. The target object detection unit 154 of the present embodiment detects, as a target object, an object that is present ahead of the vehicle 1 in a traveling direction and may come into contact with or collide with the vehicle 1. In other words, the target object detection unit 154 detects a target object present ahead of the vehicle 1 when the vehicle 1 travels forward, and detects a target object present behind the vehicle 1 when the vehicle 1 travels backward. The target object detection unit 154 detects a position, a moving speed, and a moving direction of the detected target object. The target object detection unit 154 outputs information indicating the position, the moving speed, and the moving direction of the detected target object to the risk index value acquisition unit 155.

The target object detection unit 154 may detect a target object or a relative position of the target object using a vehicle-to-vehicle communication device, a GNSS unit, or a V2X (Vehicle-to-Everything) communication device or the like in addition to the sensor such as a front camera provided in the vehicle sensor 10. The target object detection unit 154 may also detect a target object appearing in a captured image or a relative position of the target object, using a determination in a virtual environment via a server. Communication partner in the V2X communication includes other vehicles, pedestrians, networks, and infrastructures, for example.

The risk index value acquisition unit 155 acquires a risk index value of the target object detected by the target object detection unit 154. The risk index value is a value indicating the possibility of contact or collision between the vehicle 1 and the target object. The risk index value acquisition unit 155 corresponds to an index value acquisition unit.

The risk index value acquisition unit 155 receives, as an input, the information indicating the position, the moving speed, and the moving direction of the target object detected by the target object detection unit 154 and the like. In addition, the risk index value acquisition unit 155 receives, as an input, sensor data such as an image captured by the camera. In addition, the risk index value acquisition unit 155 predicts a moving line between the target object and the vehicle 1, based on the position, the moving direction, and the moving speed of the target object, the position, the moving direction, and the moving speed of the vehicle 1, a lighting state of traffic lights detected from the image captured by the camera, and the like. The risk index value acquisition unit 155 calculates a risk index value based on a position where the vehicle 1 and the target object are closest to each other, and a distance between the vehicle 1 and the target object at the position. The risk index value is obtained by, for example, scoring the position, the moving direction, and the moving speed of the target object, and the distance between the vehicle 1 and the target object, and then multiplying the scored values by a weighting coefficient to calculate the sum of the resulting values.

During a prediction of a moving line of the target object, when the target object is a vehicle, the risk index value acquisition unit 155 may take into consideration lighting states of turn signal lights and a brake light of the vehicle, and when the target object is a pedestrian, the risk index value acquisition unit 155 may take into consideration an orientation of a face of the pedestrian and the like. Similarly, during a prediction of a moving line of the vehicle 1, the risk index value acquisition unit 155 may take into consideration lighting states of turn signal lights and a brake light of the vehicle 1 obtained from the vehicle sensor 10, and may take into consideration the route being guided if the navigation device 60 is guiding the route.

In addition, the risk index value acquisition unit 155 detects a risk of contact between the vehicle 1 and a target object actually detected in an environment surrounding the vehicle 1, and may also infer and detect a risk of contact with a target object (such as a virtual vehicle or a pedestrian) that has not yet been detected, but can appear on based on visibility, the number of accidents, and the like at an intersection or the like. The risk index value acquisition unit 155 outputs the acquired risk index value to the notification determination unit 156.

The notification determination unit 156 corresponds to a determination unit. The notification determination unit 156 receives, as inputs, the information on the language, which is spoken from the driver D, acquired by the geographical characteristic acquisition unit 151, the emotion information on the driver D estimated by the driver emotion estimation unit 153, and the risk index value for each of the target objects acquired by the risk index value acquisition unit 155.

The notification determination unit 156 determines, based on the input information, whether there is a target object to be notified. When there is the target object to be notified, the notification determination unit 156 determines a type of notification and a level of notification to notify of the presence of the target object.

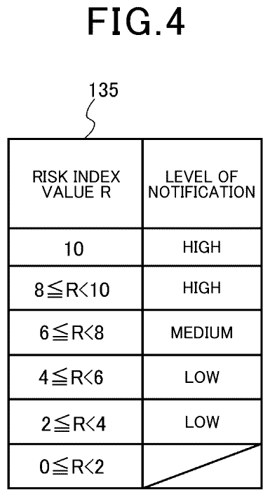

FIG. 4 is a diagram illustrating an example of the first notification setting table 135.

The first notification setting table 135 is a table in which a risk index value and a level of notification are registered in association with each other. Hereinafter, the risk index value will be referred to as a risk index value R.

First, the notification determination unit 156 determines whether there is a target object with the risk index value R, which is input from the risk index value acquisition unit 155, of 2 or more. When there is a target object with the risk index value R of 2 or more, the notification determination unit 156 determines such a target object as a target object to be notified. The risk index value R of 2 or more corresponds to a threshold value.

Furthermore, when there is a target object with the risk index value R of 2 or more, the notification determination unit 156 determines a level of notification based on the risk index value of the target object and the first notification setting table 135. In the example of the first notification setting table 135 illustrated in FIG. 4, when the risk index value R is 2≤R<4 and 4≤R<6, the level of notification is set to “low”. When the risk index value R is 6≤R<8, the level of notification is set to “medium”. When the risk index value R is 8≤R<10 and R=10, the level of notification is set to “high”.

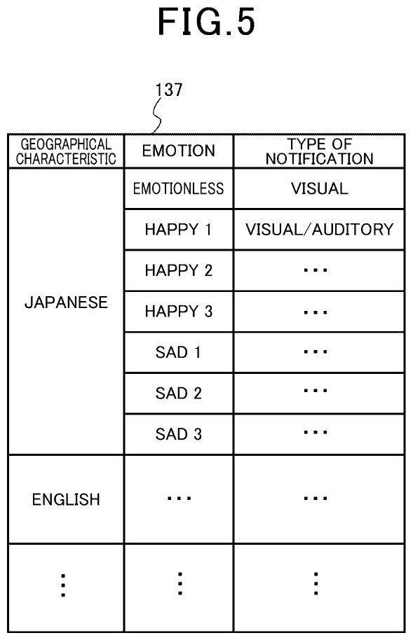

FIG. 5 is a diagram illustrating an example of the second notification setting table 137.

In the second notification setting table 137 illustrated in FIG. 5, information on the language, which is a geographical characteristic, emotions of the driver D, and types of notification are registered in association with each other. The emotions of the driver D involve “emotionless”, “happy 1”, “happy 2”, “happy 3”, “sad 1”, “sad 2”, and “sad 3”. In the second notification setting table 137, a type of notification and a level of notification are registered in association with each of these emotions.

Next, the notification determination unit 156 determines, based on the information on the language of the driver D and the emotion information of the driver D to be input, the type of HMI device 30 used for a notification of the risk present around the vehicle 1.

The notification determination unit 156 refers to the second notification setting table 137 based on the information on the language of the driver D input from the geographical characteristic acquisition unit 151 and the emotion information of the driver D input from the driver emotion estimation unit 153, and acquires a type of notification indicating the type of HMI device 30 used for the notification of the risk.

When the type of notification is visual, an image display on the touch panel 310 is selected in the present embodiment.

When the type of notification is auditory, a notification in the form of the voice output from the speaker 330 is selected in the present embodiment.

When the type of notification is tactile, the vibration of the seat generated by the seat vibration unit 350 is selected in the present embodiment.

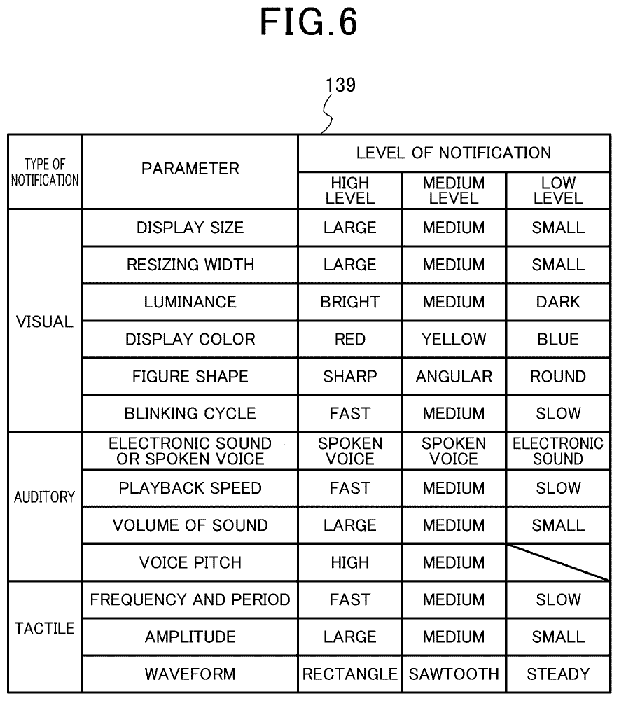

FIG. 6 is a diagram illustrating an example of the third notification setting table 139.

The third notification setting table 139 illustrated in FIG. 6 includes a visual parameter, an auditory parameter, and a tactile parameter for each type of notification and a setting for each of levels of notifications for these parameters. Regarding the parameters set for each type of notification, the visual parameter is a variable that changes a display mode of an image and a figure displayed on the touch panel 310. The auditory parameter is a variable that changes an output mode of the voice output from the speaker 330. The tactile parameter is a variable that changes an output mode of vibration output from the seat vibration unit 350.

The visual sense includes, as parameters, a display size, a resizing width, a display color, a figure shape, and a blinking cycle. These parameters correspond to the visual parameters.

The setting for each level of notification for each of the parameters is registered in the third notification setting table 139. The levels of notification include a high level of notification, a medium level of notification, and a low level of notification. Hereinafter, the high level of notification is indicated as a high level, the medium level of notification is indicated as a medium level, and the low level of notification is indicated as a low level.

When the parameter is a display size, a display size of “large” is registered as the setting for the high level, a display size of “medium” is registered as the setting for the medium level, and a display size of “small” is registered as the setting for the low level.

When the parameter is a resizing width, “large” is registered as the setting for the high level, “medium” is set as the setting for the medium level, and “small” is registered as the setting for the low level. The resizing width is a size change width by which the display size of the figure displayed on the touch panel 310 is enlarged or reduced. For example, when the resizing width is “large”, the size of the figure displayed on the touch panel 310 is significantly changed from a “large” to a “small” size and from a “small” size to a “large” size. When the display size of the figure displayed on the touch panel 310 is significantly changed in this way to attract the driver's attention.

When the parameter is luminance, luminance of “bright” is registered as the setting for the high level, luminance of “medium” is registered as the setting for the medium level, and luminance of “dark” is registered as the setting for the low level.

When the parameter is a display color, a display color of “red” is registered as the setting for the high level, a display color of “yellow” is registered as the setting for the medium level, and a display color of “blue” is registered as the setting for the low level.

When the parameter is a figure shape, a figure shape of “sharp” is registered as the setting for the high level, a figure shape of “angular” is registered as the setting for the medium level, and a figure shape of “round” is registered as the setting for the low level. The sharper the figure shape displayed on the touch panel 310, the higher the degree of risk is recognized, and the rounder the figure shape displayed on the touch panel 310, the lower the degree of risk is recognized.

When the parameter is a blinking cycle, a blinking cycle of “fast” is registered as the setting for the high level, a blinking cycle of “medium” is registered as the setting for the medium level, and a blinking cycle of “slow” is registered as the setting for the low level.

The auditory sense includes, as parameters, an electronic sound or spoken voice, a playback speed, a volume of sound, and a voice pitch. These parameters correspond to the auditory parameters.

The setting for each level of notification for each of these parameters is registered in the third notification setting table 139.

When the parameter is an electronic sound or a spoken voice, the setting for the high level is registered as “spoken voice”, the setting for the medium level is registered as “spoken voice”, and the setting for the low level is registered as “electronic sound”.

When the parameter is a playback speed, a playback speed of “fast” is registered as the setting for the high level, a playback speed of “medium” is registered as the setting for the medium level, and a playback speed of “slow” is registered as the setting for the low level.

When the parameter is a volume of sound, a volume of sound of “large” is registered as the setting for the high level, a volume of sound of “medium” is registered as the setting for the medium level, and a volume of sound of “small” is registered as the setting for the low level.

When the parameter is a voice pitch (tone), a voice pitch of “high” is registered as the setting for the high level, and a voice pitch of “medium” is registered as the setting for the medium level. At the setting for the low level, an electronic sound is output, and thus the voice pitch is not registered.

The tactile sense includes, as parameters, a frequency or a period, an amplitude, and a waveform. These parameters correspond to the tactile parameters.

The setting for each level of notification for each of these parameters is registered in the third notification setting table 139.

When the parameter is a frequency or a period, the setting for the high level is registered as “fast”, the setting for the medium level is registered as “medium”, and the setting for the low level is registered as “slow”.

When the parameter is an amplitude, the setting for the high level is registered as “large”, the setting for the medium level is registered as “medium”, and the setting for the low level is registered as “small”.

When the parameter is a waveform, the setting for the high level is registered as “rectangle”, the setting for the medium level is registered as “sawtooth”, and the setting for the low level is registered as “steady”.

The notification determination unit 156 acquires the setting of the parameters corresponding to the type of notification determined in the second notification setting table 137 and the level of notification determined in the first notification setting table 135, from the third notification setting table 139 illustrated in FIG. 6. The notification determination unit 156 outputs the acquired type of notification, the acquired level of notification, and the acquired setting of the parameters to the execution control unit 157.

The execution control unit 157 controls the operation of the HMI device 30 according to the type of notification, the level of notification, and the setting of the parameters input from the notification determination unit 156.

When the type of notification input from the notification determination unit 156 is visual, the execution control unit 157 causes the touch panel 310 to display images, figures, and text according to the setting of the parameters.

When the type of notification input from the notification determination unit 156 is auditory, the execution control unit 157 causes the speaker 330 to output a spoken voice or a voice in the form of the electronic sound according to the setting of the parameters.

When the type of notification input from the notification determination unit 156 is tactile, the execution control unit 157 controls the seat vibration unit 350 according to the setting of the parameters, and vibrates the seat in which the driver D is seated.

The second notification setting table 137 illustrated in FIG. 5 and the third notification setting table 139 illustrated in FIG. 6 are set in which geographical characteristics are reflected.

When the driver D has different cultural characteristics, which are the geographical characteristics, or social background, there may be differences in emotions evoked by the driver D, resulting in erroneous recognition of the notification using the HMI device 30. Therefore, the second notification setting table 137 and the third notification setting table 139 are registered with the setting in which the cultural characteristics, traffic environment, and social background and the like of each country or region are reflected.

For example, when the emotion of the driver D estimated by the driver emotion estimation unit 153 is “sadness”, the auditory parameter is set to output a “calm” voice that heals the “sadness” emotion of the driver D. In addition, when the emotion of the driver D estimated by the driver emotion estimation unit 153 is “drowsy”, “tired”, or “bored”, the auditory parameter is set to elevate the emotion of the driver D and create a happy emotion.

Hereinafter, examples of the setting of the second notification setting table 137 and the third notification setting table 139 will be described.

### 3. Notification Example

### Notification Example 1

For example, the display color is changed depending on the country of the driver D.

In China, the display color “white” is used as a color representing “relief” and “sadness”.

In Nigeria, the display color “red” is used as a color representing “anger”, “love”, and “fear”.

In Egypt, the display color “yellow” is used as a color representing a positive emotion such as “enjoyment”.

In Greece, the display color “purple” is used as a color representing sadness.

### Notification Example 2

For example, when risk information is notified using a human face or a face icon mark on the touch panel 310, which is visual transmission, the use of a good mark is OK in Japan, but is set to “not use” in Brazil. Furthermore, a human nodding action is OK in Japan, but is set to “not use” in India and Brazil.

### Notification Example 3

For example, in Asian and Northern European countries where physical contact is less common, a notification by a tactile stimulus is set to “not use” or a level of notification is set to “low”.

In Latin countries where physical contact is common, such as Italy, France, Spain, Portugal, and South American countries, a notification by a tactile stimulus is set to “use” or a level of notification by the tactile stimulus is set to “high”.

### Notification Example 4

For example, in Asian countries where honking is common, a notification by auditory transmission is set to “use” or a level of notification by the auditory transmission is set to “high”.

### 4. Operation of Attention Attracting Device

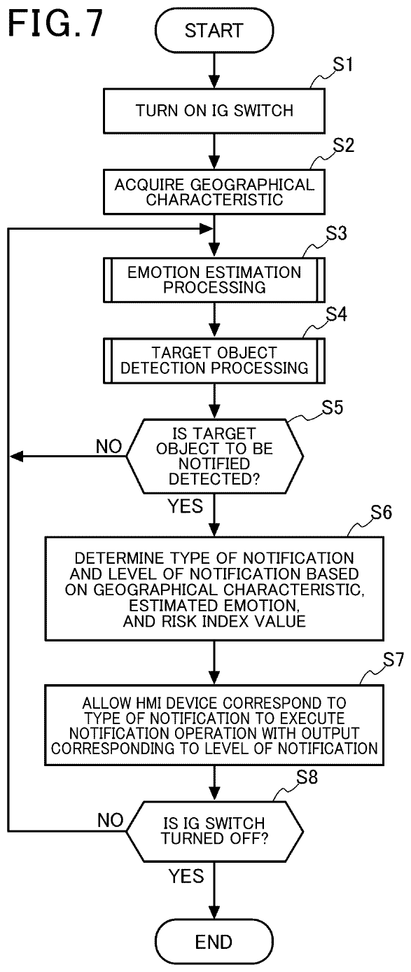

FIGS. 7 to 9 are flowcharts illustrating an operation of the attention attracting device 100.

The operation of the attention attracting device 100 will be described with reference to the flowcharts illustrated in FIGS. 7 to 9.

First, when an IG switch of the vehicle is turned on (step S1), the attention attracting device 100 acquires geographical characteristics (step S2). The geographical characteristics may be acquired from the language setting of the navigation device, for example, or the geographical characteristic may be identified by analysis of the voice spoken from the driver or the sound of a radio or music.

Next, the attention attracting device 100 executes emotion estimation processing of the driver D (step S3). After estimating the emotion of the driver D in the emotion estimation processing, the attention attracting device 100 detects a target object, which is an obstacle present around the vehicle 1, by target object detection processing (step S4).

Next, the attention attracting device 100 determines whether the target object to be notified is detected by the target object detection processing (step S5). When the attention attracting device 100 does not detect the target object to be notified (NO in step S5), the process returns to step S3.

In addition, when the attention attracting device 100 detects the target object to be notified (YES in step S5), it refers to the first notification setting table 135, the second notification setting table 137, and the third notification setting table 139, based on the geographical characteristics acquired in step S2, the emotion of the driver D identified in step S3, and the risk index value acquired in step S5, and determines the type of notification and the level of notification to notify the driver D of the presence of the risk (step S6).

Next, the attention attracting device 100 operates the HMI device 30 corresponding to the type of notification determined in step S6 with an output corresponding to the level of notification, and executes the notification operation (step S7).

Next, the attention attracting device 100 determines whether the IG switch is turned off (step S8). When the attention attracting device 100 determines that the IG switch is not turned off (NO in step S8), the process returns to the emotion estimation processing in step S3. When the attention attracting device 100 determines that the IG switch is turned off (YES in step S8), the processing flow is ended.

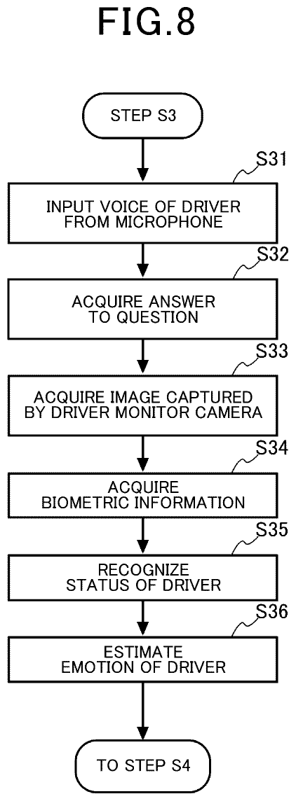

FIG. 8 is a flowchart illustrating details of the emotion estimation processing in step S3.

The emotion estimation processing will be described in detail with reference to the flowchart illustrated in FIG. 8.

First, the attention attracting device 100 acquires a voice of the driver D input from the microphone 40 (step S31). Next, the attention attracting device 100 outputs a voice to ask the driver D about his/her status from the speaker 300, and acquires an answer to the question from the microphone 40 or a touch operation (step S32). Furthermore, the attention attracting device 100 acquires an image captured by the driver monitor camera 50 (step S33) and acquires biometric information of the driver D from the wearable device 70 (step S34).

Next, the attention attracting device 100 recognizes the status of the driver D based on the information acquired in steps S31 to S34 (step S35). Next, the attention attracting device 100 refers to the emotion map 133 based on the first to fourth elements described above, and estimates the emotion of the driver D (step S36).

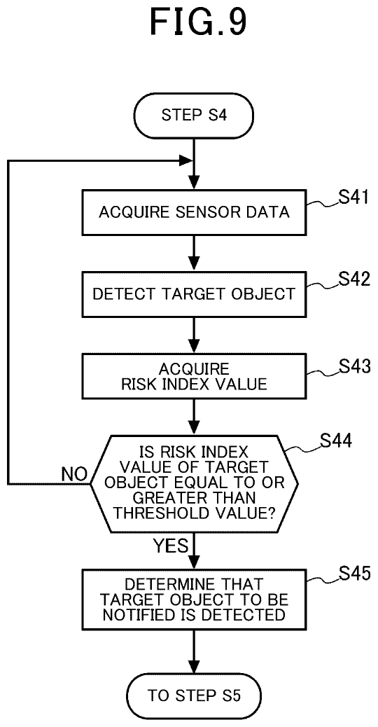

FIG. 9 is a flowchart illustrating details of the target object detection processing.

The target object detection processing will be described in detail with reference to the flowchart illustrated in FIG. 9.

First, the attention attracting device 100 acquires sensor data from the vehicle sensor 10 (step S41).

Next, the attention attracting device 100 detects a target object present around the vehicle 1 based on the sensor data (step S42), and detects a position, a moving speed, and a moving direction of the detected target object.

Next, the attention attracting device 100 acquires a risk index value of the detected target object (step S43). The attention attracting device 100, for example, scores the position, the traveling direction, and the moving speed of the target object, and the distance between the vehicle 1 and the target object, and multiplies the scored values by a weighting coefficient to calculate the sum of these values as the risk index value.

Next, the attention attracting device 100 determines whether the acquired risk index value is equal to or greater than a threshold value set in advance (step S44). When the attention attracting device 100 determines that the risk index value is not equal to or greater than the threshold value (NO in step S44), the process returns to step S41.

Next, when the attention attracting device 100 determines that the risk index value is equal to or greater than the threshold value (YES in step S44), it determines that the target object to be notified has been detected (step S45).

### 5. Other Embodiments

The above-embodiment is merely one aspect, and may be arbitrarily changed and applicable.

The case has been described in the above-described embodiment in which the visual HMI device is the touch panel 310, but the visual HMI device may also be, for example, display means such as a light emitting diode (LED) or a head-up display provided on the instrument panel 4 of the vehicle 1. The head-up display notifies of the presence of a target object that may come into contact with the vehicle 1 by displaying an image on the windshield 3 as a projection surface.

Moreover, respective components of the vehicle 1 illustrated in FIG. 2 are an example, and the specific implementation form is not particularly limited. In other words, it is not necessarily required to implement hardware corresponding to respective components, but it is of course possible to construct a configuration in which the functions of the respective components are implemented by executing a program by one processor. In addition, some of the functions implemented by software in the above-described embodiment may be implemented by hardware, or some of the functions implemented by hardware may be implemented by software.

Further, the step units of the operations illustrated in FIGS. 7 to 9 are divided according to the main processing contents, and the present invention is not limited by the manner in which the processing units are divided or the names of the processing units. Depending on the processing contents, the process may be divided into more step units. Further, one step unit may be divided so as to include more processing. In addition, the order of the steps may be changed as appropriate within the scope of the present invention.

Furthermore, when the attention attracting method using the above-described attention attracting device 100 is to be implemented using the processor 150, the program to be executed by the processor 150 can be configured with a mode of recording medium or a mode of transmission medium that transmits the program. In other words, the control program 131 can also be implemented in a state where the control program 131 is recorded on a portable information recording medium. Examples of the information recording medium may include a magnetic recording medium such as a hard disk, an optical recording medium such as a CD, and semiconductor memory devices such as a USB (Universal Serial Bus) memory and an SSD (Solid State Drive), but other recording media can also be used.

### 6. Configuration Supported by Embodiment

The above-described embodiment supports the following configurations.

### Configuration 1

An attention attracting device that notifies a driver of a vehicle of a presence of a risk using a plurality of types of HMI devices, the attention attracting device including: an index value acquisition unit that acquires, based on outputs of a plurality of sensors mounted on the vehicle, a risk index value indicating a degree of possibility of contact between the vehicle and a target object present around the vehicle; a geographical characteristic acquisition unit that acquires a geographical characteristic of the driver of the vehicle; a status recognition unit that recognizes a status of the driver of the vehicle; an emotion estimation unit that estimates an emotion of the driver based on a result of the status of the driver recognized by the status recognition unit; and a determination unit that determines a level of notification to notify the driver of the presence of the risk and a type of the HMI device to be used for notification, based on the emotion of the driver estimated by the emotion estimation unit, the geographical characteristic of the driver acquired by the geographical characteristic acquisition unit, and the risk index value acquired by the index value acquisition unit.

According to such a configuration, the level of notification to notify the driver of the presence of the risk and the type of the HMI device to be used for notification are determined, based on the geographical characteristic of the driver, the emotion of the driver, and the risk index value indicating the degree of possibility of contact with the vehicle.

In a case of notifying the driver of the presence of the risk using the plurality of types of HMI devices, there may be differences in emotions evoked by the driver depending on the cultural characteristics or social background, resulting in erroneous recognition of the notification of the presence of the risk. Therefore, when the level of notification to notify the driver of the presence of the risk and the type of the HMI device to be used for notification are determined based on the geographical characteristic of the driver and the emotion of the driver, it is possible to reduce the possibility of the driver's erroneous recognition and increase the certainty of the notification to the driver.

### Configuration 2

In the attention attracting device according to Configuration 1, the plurality of types of HMI devices includes a visual HMI device that visually transmits information to the driver, an auditory HMI device that transmits information to the driver with a voice, and a tactile HMI device that provides a tactile stimulus to the driver, and the determination unit determines, as the HMI device to be used for notification, at least one of the visual HMI device, the auditory HMI device, and the tactile HMI device, based on the emotion of the driver, the geographical characteristic of the driver, and the risk index value.

According to such a configuration, the plurality of types of HMI devices include the visual HMI device, the auditory HMI device, and the tactile HMI device. The determination unit determines, as the HMI device that notifies the driver of the presence of the risk, at least one of the visual HMI device, the auditory HMI device, and the tactile HMI device. Therefore, the presence of the risk can be notified to the driver by information transmission in the form of a visual sense, information transmission in the form of a voice, or a tactile stimulus.

### Configuration 3

In the attention attracting device according to Configuration 2, the determination unit is configured to determine a value of a visual parameter for changing an image displayed by the visual HMI device from the level of notification determined based on the risk index value, and the visual parameter includes a parameter for changing at least one of enlargement and reduction of the image, a display area of the image, display luminance of the image, a display color of the image, a shape of the image, and a blinking cycle of the image.

According to such a configuration, the value of the visual parameter is determined according to the level of notification that is determined based on the risk index value. Therefore, at least one of the enlargement and reduction of the image displayed by the visual HMI device, the display area of the image, the display luminance of the image, the color of the image, the shape of the image, and the blinking cycle of the image can be changed corresponding to the level of notification.

### Configuration 4

In the attention attracting device according to Configuration 2, the determination unit is configured to determine a value of an auditory parameter for changing a voice output by the auditory HMI device from the level of notification determined based on the risk index value, and the auditory parameter includes a parameter for changing at least one of a playback speed or a playback cycle, a volume of sound, and a voice pitch of voice data which is a source of the voice.

According to such a configuration, the value of the auditory parameter is determined according to the level of notification that is determined based on the risk index value. Therefore, at least one of the playback speed or the playback cycle, the volume of sound, and the voice pitch of voice data, which is a source of the voice output by the auditory HMI device, can be changed corresponding to the level of notification.

### Configuration 5

In the attention attracting device according to Configuration 2, the determination unit is configured to determine a value of a tactile parameter for changing a level of vibration output by the tactile HMI device from the level of notification determined based on the risk index value, and the tactile parameter includes a parameter for changing at least one of a period of the vibration, an amplitude of the vibration, and a waveform of the vibration.

According to such a configuration, the value of the tactile parameter is determined according to the level of notification that is determined based on the risk index value. Therefore, at least one of the period of the vibration, the amplitude, and the waveform of the vibration output by the tactile HMI device can be changed corresponding to the level of notification.

### Configuration 6

An attention attracting method of causing a processor mounted on an attention attracting device, which notifies a driver of a vehicle of a presence of a risk using a plurality of types of HMI devices, to execute: an index value acquisition step of acquiring, based on outputs of a plurality of sensors mounted on the vehicle, a risk index value indicating a degree of possibility of contact between the vehicle and a target object present around the vehicle; a geographical characteristic acquisition step of acquiring a geographical characteristic of the driver of the vehicle; a status recognition step of recognizing a status of the driver of the vehicle; an emotion estimation step of estimating an emotion of the driver based on a result of the status of the driver recognized in the status recognition step; and a determination step of determining a level of notification to notify the driver of the presence of the risk and a type of the HMI device to be used for notification, based on the emotion of the driver estimated in the emotion estimation step, the geographical characteristic of the driver acquired in the geographical characteristic acquisition step, and the risk index value acquired in the index value acquisition step.

According to such a configuration, the level of notification to notify the driver of the presence of the risk and the type of the HMI device to be used for notification are determined, based on the geographical characteristic of the driver, the emotion of the driver, and the risk index value indicating the degree of possibility of contact with the vehicle.

In a case of notifying the driver of the presence of the risk using the plurality of types of HMI devices, there may be differences in emotions evoked by the driver depending on the cultural characteristics or social background, resulting in erroneous recognition of the notification of the presence of the risk. Therefore, when the level of notification to notify the driver of the presence of the risk and the type of the HMI device to be used for notification are determined based on the geographical characteristic of the driver and the emotion of the driver, it is possible to reduce the possibility of the driver's erroneous recognition and increase the certainty of the notification to the driver.

### REFERENCE SIGNS LIST

1 vehicle
3 windshield
4 dashboard
10 vehicle sensor
10 A front camera
30 HMI device
40 microphone
50 driver monitor camera
60 navigation device
70 wearable device
100 attention attracting device
110 communication unit
130 storage unit
131 control program
133 emotion map
135 first notification setting table
137 second notification setting table
139 third notification setting table
150 processor
151 geographical characteristic acquisition unit
152 driver status recognition unit
153 driver emotion estimation unit
154 target object detection unit
155 risk index value acquisition unit
156 notification determination unit
157 execution control unit
310 touch panel
330 speaker
330A right speaker
330B left speaker
350 seat vibration unit

1. An attention attracting device that notifies a driver of a vehicle of a presence of a risk using a plurality of types of HMI devices, the attention attracting device comprising:
an index value acquisition unit that acquires, based on outputs of a plurality of sensors mounted on the vehicle, a risk index value indicating a degree of possibility of contact between the vehicle and a target object present around the vehicle;
a geographical characteristic acquisition unit that acquires a geographical characteristic of the driver of the vehicle;
a status recognition unit that recognizes a status of the driver of the vehicle;
an emotion estimation unit that estimates an emotion of the driver based on a result of the status of the driver recognized by the status recognition unit; and
a determination unit that determines a level of notification to notify the driver of the presence of the risk and a type of the HMI device to be used for notification, based on the emotion of the driver estimated by the emotion estimation unit, the geographical characteristic of the driver acquired by the geographical characteristic acquisition unit, and the risk index value acquired by the index value acquisition unit.

2. The attention attracting device according to claim 1, wherein
the plurality of types of HMI devices includes a visual HMI device that visually transmits information to the driver, an auditory HMI device that transmits information to the driver with a voice, and a tactile HMI device that provides a tactile stimulus to the driver, and
the determination unit determines, as the HMI device to be used for notification, at least one of the visual HMI device, the auditory HMI device, and the tactile HMI device, based on the emotion of the driver, the geographical characteristic of the driver, and the risk index value.

3. The attention attracting device according to claim 2, wherein
the determination unit is configured to determine a value of a visual parameter for changing an image displayed by the visual HMI device from the level of notification determined based on the risk index value, and
the visual parameter includes a parameter for changing at least one of enlargement and reduction of the image, a display area of the image, display luminance of the image, a display color of the image, a shape of the image, and a blinking cycle of the image.

4. The attention attracting device according to claim 2, wherein
the determination unit is configured to determine a value of an auditory parameter for changing a voice output by the auditory HMI device from the level of notification determined based on the risk index value, and
the auditory parameter includes a parameter for changing at least one of a playback speed or a playback cycle, a volume of sound, and a voice pitch of voice data which is a source of the voice.

5. The attention attracting device according to claim 2, wherein
the determination unit is configured to determine a value of a tactile parameter for changing a level of vibration output by the tactile HMI device from the level of notification determined based on the risk index value, and
the tactile parameter includes a parameter for changing at least one of a period of the vibration, an amplitude of the vibration, and a waveform of the vibration.

6. An attention attracting method of causing a processor mounted on an attention attracting device, which notifies a driver of a vehicle of a presence of a risk using a plurality of types of HMI devices, to execute:
an index value acquisition step of acquiring, based on outputs of a plurality of sensors mounted on the vehicle, a risk index value indicating a degree of possibility of contact between the vehicle and a target object present around the vehicle;
a geographical characteristic acquisition step of acquiring a geographical characteristic of the driver of the vehicle;
a status recognition step of recognizing a status of the driver of the vehicle;
an emotion estimation step of estimating an emotion of the driver based on a result of the status of the driver recognized in the status recognition step; and
a determination step of determining a level of notification to notify the driver of the presence of the risk and a type of the HMI device to be used for notification, based on the emotion of the driver estimated in the emotion estimation step, the geographical characteristic of the driver acquired in the geographical characteristic acquisition step, and the risk index value acquired in the index value acquisition step.
